(19) United States
(12) Patent Application Publication
(10) Pub. No.: US 2023/0122141 A1
(43) Pub. Date: Apr. 20, 2023

(54) TRI-BLEND BLOWING AGENT COMPOSITION FOR POLYMERIC FOAM

(71) Applicant: Owens Corning Intellectual Capital, LLC, Toledo, OH (US)

(72) Inventors: Chase Boudreaux, Canton, OH (US); Mitchell Weekley, Tallmadge, OH (US); Jeff Thomas, Mogadore, OH (US); Christine Heppe, Norton, OH (US); Billie Harris, Uniontown, OH (US); Barbara Fabian, Medina, OH (US); Xiangmin Han, Stow, OH (US); Laura Frazier, Kent, OH (US)

(21) Appl. No.: 17/965,041

(22) Filed: Oct. 13, 2022

Related U.S. Application Data
(60) Provisional application No. 63/255,480, filed on Oct. 14, 2021.

(51) Int. Cl. C08J 9/14; C08J 9/16

(52) U.S. Cl. CPC C08J 9/146; C08J 9/16; C08J 2201/03; C08J 2203/142; C08J 2203/162; C08J 2203/202; C08J 2325/06

(57) ABSTRACT

A foamable polymer composition is disclosed comprising a thermoplastic matrix polymer composition, and a tri-blend blowing agent composition. The tri-blend blowing agent comprises 5 wt. % to 55 wt. % of a fluorinated alkene having a GWP less than 5; 30 wt. % to 80 wt. % of a first co-blowing agent comprising a hydrofluorocarbon (HFC) blowing agent having a GWP less than 200; and 0.25 to 25 wt. % of a second co-blowing agent comprising an HFC blowing agent having a GWP above 500. The tri-blend blowing agent composition has a total GWP of less than 550.

### CROSS-REFERENCE TO RELATED APPLICATION(S)

This application claims priority to and any benefit of U.S. Provisional Application No. 63/255,480, filed Oct. 14, 2021, the content of which is incorporated herein by reference in its entirety.

### FIELD

This invention relates to a process for forming polymeric foams and particularly to the manufacture of extruded thermoplastic foams. This invention provides the use of a novel tri-blend blowing agent composition to form thermoplastic polymeric foams having a balance of low global warming potential and desireable foam properties.

### BACKGROUND

Polymeric foams, such as extruded polymeric foams or “XPS” foam, are generally manufactured by melting a polymeric matrix composition to form a polymeric melt and incorporating one or more blowing agents and other additives into the polymeric melt under conditions that provide for the thorough mixing of the blowing agent and the polymer, while preventing the mixture from foaming prematurely, e.g., under pressure. This mixture is then typically extruded through a single or multi-stage extrusion die to cool and reduce the pressure on the mixture, allowing the mixture to foam and produce a foamed product. As will be appreciated, the relative quantities of the polymer(s), blowing agent(s), and additives; the temperature; and the manner in which the pressure is reduced will impact the quality of the resulting foam product. As will also be appreciated, the foamable mixture is maintained under a relatively high pressure until it passes through an extrusion die and is allowed to expand in a region of reduced pressure.

The solubility of conventional blowing agents, such as chlorofluorocarbons (“CFCs”) and certain alkanes, in a polymer melt tends to reduce the melt viscosity and improve cooling of expanded polymer melts. For example, the combination of pentane and a CFC, such as Freon 11 or 12 is partially soluble in polystyrene and has been used for generating polystyrene foams that exhibited a generally acceptable appearance and physical properties such as surface finish, cell size and distribution, orientation, shrinkage, insulation property (R− value), and stiffness.

However, in response to the environmental concerns regarding the use of such CFC compounds, the widespread use and accompanying atmospheric release of such compounds in applications such as aerosol propellants, refrigerants, foam-blowing agents and specialty solvents has recently been drastically reduced or eliminated by government regulation.

The divergence away from the use of CFCs has led to utilization of alternative blowing agents, such as hydrogen-containing chlorofluoroalkanes (HCFCs). However, HCFC's still contain some chlorine and are therefore said to have an ozone depletion potential (“ODP”).

Another class of blowing agents, hydrofluorocarbons (HFC's), have been used as more ozone friendly options, offering desirable improvements, such as zero ODP and lower (but still potentially significant) global warming potential (GWP). However, these compounds are expensive, tend to be less soluble in polystyrene, and may still have significant GWP. For example, HFC-134a has a GWP of 1430.

Hydrofluoroolefin (HFO) blowing agents, which are a type of fluorinated alkene, are believed to be more environmentally friendly than traditional halogenated blowing agents. For example, HFOs are believed to have reduced ODP and GWP, compared to traditional fluorocarbon and hydrofluorocarbon blowing agents.

In addition to environmental considerations, certain blowing agents and blends of blowing agent may be flammable, depending on the particular composition and blend. Additionally, although certain individual blowing agent compositions, such as HFO-1336mzz(Z) and HFC-134a/HFC-134, are considered non-flammable, polymer foam products comprising such blowing agents or blowing agent blends may still not be able to pass combustibility tests, such as the NFPA-286 “corner room burn test,” as the heat liberated during the combustion process is dependent on the molecular composition and size of each component.

Thus, there remains a need for an environmentally friendly blowing agent composition with a reduced GWP that is capable of producing polymeric foam products with desirable physical properties and that pass both flammability and combustibility tests.

### BRIEF SUMMARY

The general inventive concepts are directed to a foamable polymer composition comprising:
a) a thermoplastic matrix polymer composition, and
b) a tri-blend blowing agent composition comprising:
   5 wt. % to 55 wt. % of a fluorinated alkene having a GWP less than 5;
   30 wt. % to 80 wt. % of a first co-blowing agent comprising a hydrofluorocarbon (HFC) blowing agent having a GWP less than 200; and
   0.25 to 25 wt. % of a second co-blowing agent comprising an HFC blowing agent having a GWP above 500. The tri-blend blowing agent composition has a total GWP of less than 550, and the foamable polymer composition produces a polymer foam having a density less than 40 kg/m³ and passes NFPA-286 corner room burn test

In any of the exemplary embodiments, the fluorinated alkene may comprise one of trans-1,1,1,4,4,4-hexafluoro-2-butene (HFO-1336mzz-Z) or 1,3,3,3-tetrafluoropropene (HFO-1234ze). The fluorinated alkene may be present in the foamable polymer composition in an amount between 0.001 moles and 0.038 moles per 100 grams of the of the matrix polymer.

In any of the exemplary embodiments, the first co-blowing agent may comprise 1,1-difluoroethane (HFC-152a), fluoroethane (HFC-161), fluoromethane (HFC-41), or combinations thereof. The second co-blowing agent may comprise 1,1,1,2-tetrafluoroethane (HFC-134a), 1,1,2,2-tetrafluoroethane (HFC-134), 1,1,1-trifluoroethane (HFC-143a), difluoromethane (HFC-32), pentafluoro-ethane (HFC-125), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-236cb), 1,1,2,3,3-pentafluoropropane (HFC-245ea), 1,1,1,2,3pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), or combinations thereof. In any of the exemplary embodiments, the second co-blowing agent may be present in an amount between 0.0005 moles and 0.03 moles per 100 grams of the matrix polymer, such as less than 0.020 moles/100 grams of matrix polymer.

In any of the exemplary embodiments, the matrix polymer may be selected from the group consisting of alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polymethylmethacrylate, polyacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyphenylene sulfide, acetal resins, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

In any of the exemplary embodiments, the tri-blend blowing agent composition may have a GWP of no greater than 300. The tri-blend blowing agent composition may be free of at least one of water and carbon dioxide.

Further exemplary embodiments are directed to a foamed polymeric insulation product comprising a polymeric foam composition formed from a foamable polymer composition comprising:
a) a thermoplastic matrix polymer composition, and
b) a tri-blend blowing agent composition comprising:
   5 wt. % to 55 wt. % of trans-1,1,1,4,4,4-hexafluoro-2-butene (Z-HFO-1336mzz);
   30 wt. % to 75 wt. % of a first co-blowing agent comprising a hydrofluorocarbon (HFC) blowing agent having a GWP less than 200; and
   0.25 to 25 wt. % of a second co-blowing agent comprising an HFC blowing agent having a GWP above 500. The tertiary blowing agent composition has a total GWP of less than 550. The foamable polymer composition produces a polymer foam having compressive strength between 41 psi and 48 psi and passes NFPA-286 corner room burn test.

In any of the exemplary embodiments, the insulation product may have a thermal resistance value (R-value) after 180 days of at least 4.75 per inch, including at least 5 per inch.

In any of the exemplary embodiments, the foamable polymer composition may be free of graphite.

In any of the exemplary embodiments, the insulation product may have a calculated heat of combustion that is less than 1100 kJ-mol⁻¹.

Further exemplary embodiments are directed to a foamable polymer composition comprising:
a) 85 wt. % to 95 wt. % of a thermoplastic matrix polymer composition, and
b) 5 wt. % to 10 wt. % of a tri-blend blowing agent composition, the blowing agent composition comprising:
   0.5 wt. % to 3 wt. % of trans-1,1,1,4,4,4-hexafluoro-2-butene (Z-HFO-1336mzz), based on the total weight of the foamable polymer composition;
   3 wt. % to 5 wt. % of a first co-blowing agent comprising a hydrofluorocarbon (HFC) blowing agent having a GWP less than 200, based on the total weight of the foamable polymer composition; and
   0.01 to 2 wt. % of a second co-blowing agent comprising an HFC blowing agent having a GWP above 500, based on the total weight of the foamable polymer composition. The tertiary blowing agent composition has total GWP of less than 550, and the foamable polymer composition produces a polymer foam having a density less than 40 kg/m³ and passes NFPA-286 corner room burn test

Yet further exemplary embodiments are directed to a method of manufacturing polymer foam, comprising:
a) providing a matrix polymer melt into an extruder;
b) injecting a tri-blend blowing agent composition into the matrix polymer melt within the extruder to form a foamable polymer composition, wherein the tri-blend blowing agent comprises:
   5 wt. % to 55 wt. % of a fluorinated alkene having a GWP less than 5;
   30 wt. % to 75 wt. % of a first co-blowing agent comprising a hydrofluorocarbon (HFC) blowing agent having a GWP less than 200; and
   0.25 to 25 wt. % of a second co-blowing agent comprising an HFC blowing agent having a GWP above 500; and
c) extruding the foamable polymer composition to form a polymer foam. The tertiary blowing agent composition has a total GWP of less than 550 and the polymer foam has a compressive strength between 41 psi and 48 psi and passes NFPA-286 corner room burn test.

In any of the exemplary embodiments, the polymer foam may have a thermal resistance value (R-value) after 180 days of at least 5 per inch and a heat of combustion that is less than 1100 kJ-mol⁻¹.

The foregoing and other objects, features, and advantages of the general inventive concepts will become more readily apparent from a consideration of the detailed description that follows.

### DESCRIPTION OF THE FIGURES

The advantages of the inventive concepts will be apparent upon consideration of the following detailed disclosure, especially when taken in conjunction with the accompanying drawings wherein:

FIG. 1 is a schematic drawing of an exemplary extrusion apparatus useful for practicing methods according to the invention.

FIG. 2 is a graphical illustration of the NFPA-286 “corner room burn” heat release results for double stacked 1-inch XPS foam boards produced with the blowing agent blends provided in Table 4.

FIG. 3 is a graphical illustration of the NFPA-286 “corner room burn” heat release results for double stacked 1-inch XPS foam boards produced with the blowing agent blends provided in Table 6.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

As used in the specification and the appended claims, the singular forms “a,” “an,” and “the” are intended to include the plural forms as well, unless the context clearly indicates otherwise. To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the insulation product and vice versa; features described herein in relation to the method may be applicable to the foamable polymer composition and vice versa; and features described herein in relation to the insulation product may be applicable to the foamable polymer composition and vice versa.

Every numerical range given throughout this specification and claims will include every narrower numerical range that falls within such broader numerical range, as if such narrower numerical ranges were all expressly written herein. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

As used herein, the term “blowing agent” is understood to include physical (e.g., dissolved gaseous agents) or chemical blowing agents (e.g., a gas generated by decomposition). A blowing agent is generally added to a molten polymer, e.g., in an extruder, and under the proper conditions, to initiate foaming to produce a foamed thermoplastic. The blowing agent expands the resin and forms cells (e.g., open or closed pores). As the resin hardens or cures, foam is produced with either the blowing agent trapped in the cells or ambient air displaces the blowing agent in the cells. The blowing agents discussed herein are preferred to be environmentally acceptable blowing agents (e.g., they are generally safe for the environment) as would be recognized by one of ordinary skill in the art.

As used herein, unless specified otherwise, the values of the constituents or components of the blowing agent or other compositions are expressed in weight percent or % by weight of each ingredient in the composition.

The present invention relates to a polymeric foam and polymeric foam products, such as extruded or expanded polystyrene foams, formed from a composition that contains a foamable polymer material, and a novel tri-blend blowing agent composition having a balance of low global warming potential and suitable foam properties.

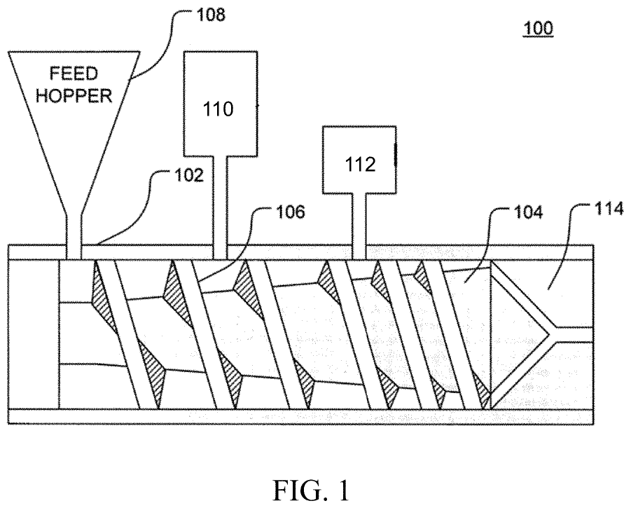

FIG. 1 illustrates a traditional extrusion apparatus 100 useful for practicing methods according to the present invention. The extrusion apparatus 100 may comprise a single or double (not shown) screw extruder including a barrel 102 surrounding a screw 104 on which a spiral flight 106 is provided, configured to compress, and thereby, heat material introduced into the screw extruder. As illustrated in FIG. 1, the polymeric composition may be conveyed into the screw extruder as a flowable solid, such as beads, granules or pellets, or as a liquid or semi-liquid melt, from one or more (not shown) feed hoppers 108.

As the basic polymeric composition advances through the screw extruder, the decreasing spacing of the flight 106, define a successively smaller space through which the polymer composition is forced by the rotation of the screw. This decreasing volume acts to increase the temperature of the polymer composition to obtain a polymeric melt (if solid starting material was used) and/or to increase the temperature of the polymeric melt.

As the polymer composition advances through the screw extruder 100, one or more ports may be provided through the barrel 102 with associated apparatus 110, 112 for injecting one or more blowing agents and optional additives into the polymer composition. Once the blowing agent(s) have been introduced into the polymer composition, the resulting mixture is subjected to some additional blending sufficient to distribute each of the components generally uniformly throughout the polymer composition to obtain a polymeric foamable composition.

The polymeric foamable composition is then forced through an extrusion die 114 and exits the die into a region of reduced pressure (which may be below atmospheric pressure), thereby allowing the blowing agent to expand and produce a polymeric foam material. This pressure reduction may be obtained gradually as the extruded polymeric mixture advances through successively larger openings provided in the die or through some suitable apparatus (not shown) provided downstream of the extrusion die for controlling to some degree the manner in which the pressure applied to the polymeric mixture is reduced. The polymeric foam may also be subjected to additional processing such as calendaring, water immersion, cooling sprays or other operations to control the thickness and other properties of the resulting polymeric foam product.

The foamable polymer composition is the backbone of the formulation and provides strength, flexibility, toughness, and durability to the final product. The foamable polymer composition is not particularly limited, and generally, any polymer capable of being foamed may be used as the foamable polymer in the resin mixture (referred to herein as the “matrix polymer”). The matrix polymer may be thermoplastic or thermoset. The particular polymer composition may be selected to provide sufficient mechanical strength and/or to the process utilized to form final foamed polymer products. In addition, the matrix polymer is preferably chemically stable, that is, generally non-reactive, within the expected temperature range during formation and subsequent use in a polymeric foam.

As used herein, the term “polymer” is generic to the terms “homopolymer,” “copolymer,” “terpolymer,” and combinations of homopolymers, copolymers, and/or terpolymers. Non-limiting examples of suitable foamable polymers for use as the matrix polymer herein include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

In one exemplary embodiment, the foamable matrix polymer is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer.

Examples of alkenyl aromatic polymers include, but are not limited to, those alkenyl aromatic polymers derived from alkenyl aromatic compounds such as styrene, alpha-methylstyrene, ethylstyrene, vinyl benzene, vinyl toluene, chlorostyrene, and bromostyrene. In at least one embodiment, the alkenyl aromatic polymer is polystyrene.

In certain exemplary embodiments, minor amounts of monoethylenically unsaturated monomers such as C₂ to C₆ alkyl acids and esters, ionomeric derivatives, and C₂ to C₆ dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In certain exemplary embodiments, the matrix polymer may be formed substantially of (e.g., greater than 95 percent), and in certain exemplary embodiments, formed entirely of polystyrene. The matrix polymer may be present in the foamable polymer composition in an amount from 60% to 99% by weight, in an amount from 60% to 96% by weight, in an amount from 70% to 95% by weight, or in an amount from 85% to 94% by weight. In certain exemplary embodiments, the matrix polymer may be present in an amount from 90% to 99% by weight. As used herein, the terms “% by weight” and “wt. %” are used interchangeably and are meant to indicate a percentage based on 100% of the total weight of the foamable polymer composition.

As mentioned above, a novel tri-blend blowing agent composition has been discovered for the production of polymeric foams having a balance of low global warming potential and suitable foam properties, including fire performance. The tri-blend blowing agent composition comprises a low GWP fluorinated alkene, such as hydrofluoroolefins (HFOs) and hydrochlorofluoroolefins (HCFOs). The fluorinated alkene blowing agent may include, for example, 1,1,1,4,4,4-hexafluoro-2-butene (HFO-1336mzz) (including cis (HFO-1336mzz-Z) and/or trans (HFO-1336mzz-E) isomers thereof); and (cis and/or trans)-1,3,3,3-tetrafluoropropene (HFO-1234ze), particularly the trans isomer. HFO-1336mzz-Z has a GWP of 2 and an ozone depletion potential (ODP) of zero. Similarly, HFO-1234ze has a GWP of less than 1 and an ODP of zero. In some exemplary embodiments, the low GWP fluorinated alkene has a GWP of less than 50, such as less than 30, less than 25, less than 15, less than 10, less than 5, less than 2.5, or less than 1.

The fluorinated alkene is present in the tri-blend blowing agent composition in at least 5 wt. %, including at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %. In any of the exemplary embodiments, the fluorinated alkene is present in the tri-blend blowing agent in an amount no greater than 55 wt. %, including amounts no greater than 50 wt. %, no greater than 47 wt. %, no greater than 45 wt. %, no greater than 42 wt. %, no greater than 40 wt. %, no greater than 37 wt. %, no greater than 35 wt. %, no greater than 32 wt. %, no greater than 30 wt. %, and no greater than 25 wt. %. In any of the exemplary embodiments, the fluorinated alkene may be present in the tri-blend blowing agent composition in an amount between 5 wt. % and 55 wt. %, including, for example, between 8 wt. % and 50 wt. %, between 10 wt. % and 40 wt. %, between 12 wt. % and 35 wt. %, between 15 wt. % and 30 wt. %, and between 17 wt. % and 28 wt. %.

The amount of fluorinated alkene may alternatively be characterized by the amount present in the foamable polymer composition. Thus, when characterized in this way the fluorinated alkene may be present in the foamable polymer composition in at least 0.3 wt. %, including at least 0.5 wt. %, at least 0.7 wt. %, at least 1 wt. %, at least 1.2 wt. %, at least 1.5 wt. %, at least 2 wt. %, at least 2.3 wt. %, at least 2.5 wt. %, at least 2.7 wt. %, and at least 3 wt. %. In any of the exemplary embodiments, the fluorinated alkene may be present in the foamable polymer composition in an amount no greater than 5 wt. %, including amounts no greater than 4.5 wt. %, no greater than 4 wt. %, no greater than 3.8 wt. %, no greater than 3.5 wt. %, no greater than 3.2 wt. %, no greater than 3 wt. %, no greater than 2.8 wt. %, no greater than 2.5 wt. %, no greater than 2.3 wt. %, and no greater than 2 wt. %. In any of the exemplary embodiments, the fluorinated alkene may be present in the tri-blend blowing agent composition in an amount between 0.5 wt. % and 4.0 wt. %, including, for example, between 0.8 wt. % and 3.8 wt. %, between 1 wt. % and 3.2 wt. %, between 1.2 wt. % and 3 wt. %, between 1.5 wt. % and 2.75 wt. %, and between 1.7 wt. % and 2.5 wt. %.

The amount of fluorinated alkene may alternatively be characterized by the molar amount per 100 grams of the of the matrix polymer. Thus, when characterized in this way the fluorinated alkene may be present in the foamable polymer composition in an amount less than 0.1 moles per 100 grams of the of the matrix polymer, including no greater than 0.05 moles, no greater than 0.045 moles, no greater than 0.04 moles, no greater than 0.038 moles, no greater than 0.035 moles, no greater than 0.03 moles, no greater than 0.02 moles, no greater than 0.017 moles, and no greater than 0.01 moles. In any of the exemplary embodiments, the fluorinated alkene may be present in foamable polymer composition in an amount between 0.0005 moles and less than 0.04 moles per 100 grams of the of the matrix polymer, including between 0.001 moles and 0.038 moles, between 0.005 moles and 0.035 moles, and between 0.01 moles and 0.030 moles per 100 grams of the of the matrix polymer.

In some exemplary embodiments, the blowing agent comprises HFO-1336mzz-Z and is substantially free of additional fluorinated alkenes. Although HFO-1336mzz-Z is considered non-flammable, a particular test, the NFPA-286 “corner room burn” test measures the combustibility of the foam whereby all components are burned and release additional energy in the form of heat measured in British thermal units (BTU). The amount of heat liberated during the combustion process is dependent on each component's size and molecular composition. As HFO-1336mzz(Z) is a relatively large molecule and contains a double bond, which is significantly more reactive than a single bond, HFO-1336mzz(Z) alone does not pass the NFPA-286 burn test.

Accordingly, the tri-blend blowing agent composition further includes a dual co-blowing agent mixture to improve the fire performance of foam produced with the tri-blend blowing agent. The dual co-blowing agent mixture includes a first co-blowing agent having a GWP less than 200. In any of the exemplary embodiments, the first co-blowing agent may have a GWP less than 150, including less than 130, and less than 100. In some exemplary embodiments, the first co-blowing agent comprises a hydrofluorocarbon (HFC), such as, for example, 1,1-difluoroethane (HFC-152a), fluoroethane (HFC-161), fluoromethane (HFC-41), or combinations thereof.

The first co-blowing agent is present in the tri-blend blowing agent composition in at least 25 wt. %, including at least 27 wt. %, at least 30 wt. %, at least 32 wt. %, at least 35 wt. %, at least 38 wt. %, at least 40 wt. %, at least 43 wt. %, at least 45 wt. %, at least 47 wt. %, and at least 50 wt. %. In any of the exemplary embodiments, the first co-blowing agent is present in the tri-blend blowing agent in an amount no greater than 75 wt. %, including amounts no greater than 70 wt. %, no greater than 67 wt. %, no greater than 65 wt. %, no greater than 62 wt. %, no greater than 60 wt. %, no greater than 57 wt. %, no greater than 55 wt. %, no greater than 52 wt. %, and no greater than 50 wt. %. In any of the exemplary embodiments, the first co-blowing agent may be present in the tri-blend blowing agent composition in an amount between 25 wt. % and 75 wt. %, including, for example, between 30 wt. % and 70 wt. %, between 32 wt. % and 67 wt. %, between 36 wt. % and 60 wt. %, between 38 wt. % and 57 wt. %, and between 40 wt. % and 55 wt. %.

When characterizing the first co-blowing agent by its weight percent present in the foamable polymer composition, the first co-blowing agent is present in at least 3 wt. %, including at least 3.2 wt. %, at least 3.5 wt. %, at least 3.7 wt. %, and at least 3.9 wt. %. In any of the exemplary embodiments, the first co-blowing agent may be present in the foamable polymer composition in an amount no greater than 6 wt. %, including amounts no greater than 5.5 wt. %, no greater than 5 wt. %, no greater than 4.8 wt. %, no greater than 4.5 wt. %, no greater than 4.2 wt. %, no greater than 4 wt. %, and no greater than 3.9 wt. %. In any of the exemplary embodiments, the first co-blowing agent may be present in the tri-blend blowing agent composition in an amount between 3 wt. % and 5 wt. %, including, for example, between 3.2 wt. % and 4.8 wt. %, between 3.4 wt. % and 4.5 wt. %, and between 3.6 wt. % and 4 wt. %.

The amount of first co-blowing agent may alternatively be characterized by the molar amount per 100 grams of the of the matrix polymer. Thus, when characterized in this way the first co-blowing agent may be present in the foamable polymer composition in an amount between 0.001 moles and less than 0.1 moles per 100 grams of the of the matrix polymer, including between 0.01 moles and 0.09 moles, between 0.03 moles and 0.08 moles, and between 0.04 moles and 0.075 moles per 100 grams of the of the matrix polymer.

The dual co-blowing agent mixture further comprises a small amount of a second co-blowing agent having a GWP greater than 500. In any of the exemplary embodiments, the second co-blowing agent may have a GWP greater than 800, including greater than 1000, and greater than 1200. The second co-blowing agent may comprise a hydrofluorocarbon (HFC), such as, for example, 1,1,1,2-tetrafluoroethane (HFC-134a), 1,1,2,2-tetrafluoroethane (HFC-134), 1,1,1-trifluoroethane (HFC-143a), difluoromethane (HFC-32), pentafluoro-ethane (HFC-125), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-236cb), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

The second co-blowing agent is present in an amount high enough to decrease the blowing agent's overall heat of combustion, while being low enough to maintain a collective blowing agent GWP of no greater than 550, or preferably no greater than 450. Particularly, the second co-blowing agent is present in an amount no greater than 25 wt. %, including amounts no greater than 20 wt. %, no greater than 17 wt. %, no greater than 15 wt. %, no greater than 12 wt. %, no greater than 10 wt. %, no greater than 8 wt. %, no greater than 6 wt. %, no greater than 4 wt. %, no greater than 2 wt. %, no greater than 1.5 wt. %, no greater than 1.2 wt. %, no greater than 1 wt. %, no greater than 0.7 wt. %, and no greater than 0.5 wt. %, based on the weight of the tri-blend blowing agent composition. In any of the exemplary embodiments, the second co-blowing agent may be present in the tri-blend blowing agent composition in at least 0.1 wt. %, including at least 0.25 wt. %, at least 0.5 wt. %, at least 0.75 wt. %, at least 0.9 wt. %, at least 1 wt. %, at least 1.5 wt. %, at least 2 wt. %, at least 2.5 wt. %, at least 3 wt. %, at least 3.5 wt. %, at least 4 wt. %, at least 4.5 wt. %, and at least 5 wt. %. In any of the exemplary embodiments, the second co-blowing agent may be present in the tri-blend blowing agent composition in an amount between 0.25 wt. % and 25 wt. %, including, for example, between 0.5 wt. % and 20 wt. %, between 0.75 wt. % and 18 wt. %, between 1 wt. % and 16 wt. %, between 1.5 wt. % and 14 wt. %, between 2 wt. % and 13 wt. %, between 2.2 wt. % and 11 wt. %, and between 2.5 wt. % and 9 wt. %.

When characterizing the second co-blowing agent by its weight percent present in the foamable polymer composition, the second co-blowing agent is present in at least 0.01 wt. %, including at least 0.05 wt. %, at least 0.08 wt. %, at least 0.1 wt. %, at least 0.25 wt. %, at least 0.5 wt. %, at least 0.8 wt. %, and at least 1 wt. %. In any of the exemplary embodiments, the second co-blowing agent may be present in the foamable polymer composition in an amount no greater than 2.5 wt. %, including amounts no greater than 2 wt. %, no greater than 1.8 wt. %, no greater than 1.5 wt. %, no greater than 1.2 wt. %, no greater than 1 wt. %, no greater than 0.8 wt. %, no greater than 0.6 wt. %, no greater than 0.5 wt. %. In any of the exemplary embodiments, the second co-blowing agent may be present in the tri-blend blowing agent composition in an amount between 0.01 wt. % and 2 wt. %, including, for example, between 0.05 wt. % and 1.8 wt. %, between 0.08 wt. % and 1.7 wt. %, between 0.1 wt. % and 1.5 wt. %, and between 0.25 wt. % and 1 wt. %.

The amount of second co-blowing agent may alternatively be characterized by the molar amount per 100 grams of the of the matrix polymer. Thus, when characterized in this way, the second co-blowing agent may be present in the foamable polymer composition in an amount between 0.0001 moles and less than 0.05 moles per 100 grams of the of the matrix polymer, including between 0.0005 moles and 0.03 moles, between 0.001 moles and 0.02 moles, and between 0.005 moles and 0.015 moles per 100 grams of the of the matrix polymer.

As mentioned above, the tri-blend blowing agent composition has a GWP below 550, and particularly below 450. In any of the exemplary embodiments, the tri-blend blowing agent composition may have a GWP no greater than 400, including no greater than 350, no greater than 300, no greater than 250, no greater than 225, no greater than 200, no greater than 175, and no greater than 150.

The tri-blend blowing agent composition is present in an amount from 2 wt. % to 12 wt. %, and in some exemplary embodiments, from 3 wt. % to 10 wt. %, including from 5 wt. % to 9 wt. %, and between 6 wt. % and 8 wt. %, based upon the total weight of the foamable polymeric mixture.

Optional additives such as infrared attenuating agents, processing aids, nucleating agents, plasticizing agents, pigments, elastomers, extrusion aids, antioxidants, fillers, antistatic agents, biocides, termite-ocide; surfactants, colorants; oils; waxes; flame retardant synergists; and/or UV absorbers may be incorporated into the foamable composition. These optional additives may be included in amounts necessary to obtain desired characteristics of the foamable gel or resultant extruded foam products. The additives may be added to the foamable composition or they may be incorporated in the foamable composition before, during, or after the polymerization process used to make the polymer.

As mentioned above, the foamable polymer composition may further contain at least one infrared attenuating agent (IAA), which are generally included in foamable compositions to improve the R-value of the foam product. Although the infrared attenuating agent tends to improve the R-value for foam products, the addition of infrared attenuating agents also decreases the cell size of the cells in the foam, which results in undesirable increase in density and product cost. Thus, in some exemplary embodiments, the infrared attenuating agent may be able to be minimized or even excluded from the present foamable composition when using the tri-blend blowing agent blend disclosed herein and the foam produced from the foamable composition may still achieve an R-value of at least 4.5. In some exemplary embodiments, a foamable composition comprising the tri-blend blowing agent disclosed herein and less than 0.05 wt. % of an infrared attenuating agent, achieves an R-value of at least 5.

However, in some exemplary embodiments, an IAA may be included in an amount up to 5 wt. %, based on the weight of foamable composition. In other embodiments, the infrared attenuating agent may be present in an amount up to 3% by weight, up to 2% by weight, or up to 1% by weight. In some exemplary embodiments, the infrared attenuating agent is present in the composition in an amount less than or equal to 0.5% by weight, such as between 0.1% to and 0.5 wt. %, or between 0.15 and 0.3 wt. %.

Non-limiting examples of suitable IAAs for use in the present composition include graphite, nanographite, carbon black, powdered amorphous carbon, asphalt, granulated asphalt, milled glass, fiber glass strands, mica, black iron oxide, metal flakes or powder (for example, aluminum flakes or powder), carbon nanotube, nanographene platelets, carbon nanofiber, activated carbon, titanium dioxide, and combinations thereof.

In at least one exemplary embodiment, the IAA is nanographite. The nanographite can be multilayered by furnace high temperature expansion from acid-treated natural graphite or microwave heating expansion from moisture saturated natural graphite. In addition, the nanographite may be multi-layered nanographite which has at least one dimension less than 100 nm. In some exemplary embodiments, the nanographite has at least two dimensions less than 100 nm.

The nanographite may or may not be chemically or surface modified and may be compounded in a polymer, which is used both as a medium and a carrier for the nanographite. Possible carriers for the nanographite include polymer carriers such as, but not limited to, polymethyl methacrylate (PMMA), polystyrene, styrene-acrylonitrile (SAN) copolymer, polyvinyl alcohol (PVOH), and polyvinyl acetate (PVA). In exemplary embodiments, the nanographite is substantially evenly distributed throughout the foam. As used herein, the phrase “substantially evenly distributed” is meant to indicate that the substance (for example, nanographite) is evenly distributed or nearly evenly distributed within the foam.

The foamable composition may further contain a fire retarding agent in an amount up to 5% or more by weight. For example, fire retardant chemicals may be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymeric flame retardant such as brominated polymeric flame retardant, phosphoric compounds, and combinations thereof.

Once the tri-blend blowing agent composition and optional additional additives have been introduced into the foamable polymer composition, the resulting mixture is subjected to some additional blending sufficient to distribute each of the additives generally uniformly throughout the polymer composition to obtain an extrusion or expandable composition.

The foamable composition disclosed herein may produce a rigid, foamed polymeric insulation product via an extrusion process. Extruded foams have a cellular structure with cells defined by cell membranes and struts. Struts are formed at the intersection of the cell membranes, with the cell membranes covering interconnecting cellular windows between the struts.

The polymeric insulation product comprises at least substantially closed cellular foams with an average density of less than 45 kg/m³. In any of the exemplary embodiments, the polymeric insulation product has an average density of less than 42 kg/m³, including less than 40 kg/m³, less than 38 kg/m³, and less than 36 kg/m³. In some exemplary embodiments, the polymeric insulation product has an average density of less than 10 pcf (pound per cubic foot), including less than 5 pcf, less than 3 pcf, and less than 2.5 pcf. In any of the exemplary embodiments, the polymeric insulation product has a density of 2.4 pcf or less, or 2.25 pcf or less, or 2.2 pcf or less. In any of the exemplary embodiments, the polymeric insulation product has an average density between 1.5 pcf and 2.4 pcf, including between 1.61 pcf and 2.3 pcf, and between 1.8 pcf and 2.28 pcf.

It is to be appreciated that the phrase “substantially closed cell” is meant to indicate that all or nearly all of the cells in the cellular structure of the polymer insulation product are closed. For example, “substantially closed cell” may be meant to indicate that not more than 30% of the cells are open cells, and particularly, not more than 10%, or more than 5% are open cells, or otherwise “non-closed” cells. The closed cell structure helps to increase the R-value of a formed, foamed insulation product. It is to be appreciated, however, that it is within the purview of the present invention to produce an open cell structure, although such an open cell structure is not an exemplary embodiment.

The average cell size of the polymer insulation product may range from 0.005 mm (5 microns) to 0.6 mm (600 microns) and, in some exemplary embodiments, from 0.05 mm (50 microns) to 0.4 mm (400 microns), or from 0.1 mm (100 microns) to 0.2 mm (200 microns).

Additionally, the polymer insulation product produced from the foamable composition disclosed herein demonstrates insulation values (R-values) of 4 to 7 per inch, and maintains an R-value of at least 4 after 180 days. In at least one embodiment, the R-value is 5 per inch. The polymeric insulation product may be used to form a variety of products, such as a rigid insulation board, insulation foam, packaging product, building insulation, and underground insulation (for example, highway, airport runway, railway, and underground utility insulation).

The incorporation of a small amount the second co-blowing agent, although increasing the overall GWP of the blowing agent composition slightly, allows for the production of a polymer insulation product with a low enough heat of combustion (ΔHc) to pass the NFPA-286 “corner room burn” test. Particularly, the polymer insulation product has a heat of combustion that is less than 1,200 kJ·mol⁻¹, such as less than 1,100 kJ·mol⁻¹, less than 1,050 kJ·mol⁻¹, less than 1,025 kJ·mol⁻¹, and less than 1,000 kJ·mol⁻¹. Additionally, small levels of the second co-blowing agent in the tri-blend blowing agent composition enhances the blowing efficiency, thereby making the production of low density foam at atmospheric conditions easier to achieve.

The polymeric foamable composition additionally may produce extruded foams that have a high compressive strength, which defines the capacity of a foam material to withstand axially directed pushing forces. In some exemplary embodiments, the polymeric foamable composition has a compressive strength within the desired range for extruded foams, which is between 6 and 120 psi. In some exemplary embodiments, the polymeric foamable composition has a compressive strength between 10 and 110 psi, including between 20 and 100 psi, between 30 and 80 psi, and between 35 and 60 psi. In various exemplary embodiments, the polymeric foamable composition has a compressive strength between 40 and 50 psi.

The inventive concepts have been described above both generally and with regard to various exemplary embodiments. Although the general inventive concepts have been set forth in what is believed to be exemplary illustrative embodiments, a wide variety of alternatives known to those of skill in the art can be selected within this disclosure. The general inventive concepts are not otherwise limited, except for those instances when presented in specific claims. Additionally, the following examples are included for the purposes of illustration, but do not limit the scope of the general inventive concepts described herein

### Example 1

Extruded polystyrene foam samples prepared using a twin screw pilot line extruder. Polystyrene was melted in the extruder and mixed with an injected blowing agent composition to form a homogeneous foamable composition. The foamable composition (excluding the blowing agent) included 98.4 wt. % polystyrene, 1.0 wt. % flame retardant masterbatch, and 0.60 wt. % graphite masterbatch. Tri-blend blowing agent blends were included with varying concentrations of fluorinated alkene and dual co-blowing agent mixtures. The foamable composition was then cooled to the right foaming conditions, including a die temperature between 110° C. and 130° C. and foaming die pressure between 800 and 1100 psi. The foamable compositions were then extruded to produce 1-inch XPS foam samples. Each of the blowing agent compositions are provided below in Table 1.

TABLE 1
Exemplary tertiary blowing agent blends

| | Wt. % based on total weight | | | | | | | |
|---|---|---|---|---|---|---|---|---|
| | of the foamable mixture | | | | Amount of blowing agent in moles | | | |
| Sample | HFC- | HFC- | HFO- | Total | HFC- | HFC- | HFO- | Total |
| No | 134a | 152a | 1336mzz | BA | 134a | 152a | 1336mzz | Gas |
| 1 | 1.83 | 4.80 | 1.17 | 7.80 | 0.0179 | 0.0726 | 0.0071 | 0.0977 |
| 2 | 1.60 | 4.80 | 1.40 | 7.80 | 0.0157 | 0.0726 | 0.0085 | 0.0968 |
| 3 | 1.37 | 4.80 | 1.64 | 7.81 | 0.0134 | 0.0726 | 0.0100 | 0.0960 |
| 4 | 1.13 | 4.80 | 1.87 | 7.80 | 0.0111 | 0.0726 | 0.0114 | 0.0951 |
| 5 | 0.90 | 4.80 | 2.11 | 7.81 | 0.0088 | 0.0726 | 0.0129 | 0.0943 |
| 6 | 0.66 | 4.80 | 2.34 | 7.80 | 0.0065 | 0.0726 | 0.0143 | 0.0933 |
| 7 | 0.43 | 4.80 | 2.57 | 7.80 | 0.0042 | 0.0726 | 0.0157 | 0.0925 |
| 8 | 0.20 | 4.80 | 2.81 | 7.81 | 0.0020 | 0.0726 | 0.0171 | 0.0917 |
| 9 | 0.08 | 4.80 | 2.93 | 7.81 | 0.0008 | 0.0726 | 0.0179 | 0.0913 |
| 10 | 0.00 | 4.80 | 3.00 | 7.80 | 0.0000 | 0.0726 | 0.0183 | 0.0909 |

As illustrated in Table 2, each of the novel tertiary blowing agent blends maintained a total GWP below 450. Additionally, the heat of combustion decreases with increasing HFC-134a, which indicates that the foam should have better flammability properties, and the blowing agent efficiency improves, as shown below.

TABLE 2
Calculated GWP, blowing agent efficiency, and heat of combustion
values for the exemplary blowing agent blends in Table 1

| | | BA Efficiency | Calc. −ΔHc |
|---|---|---|---|
| Sample No. | GWP | @121° C. | (kJ · mol⁻¹) |
| 1 | 421 | 418 | 934 |
| 2 | 378 | 416 | 945 |
| 3 | 335 | 415 | 956 |
| 4 | 292 | 414 | 968 |
| 5 | 250 | 412 | 979 |
| 6 | 207 | 411 | 991 |
| 7 | 164 | 409 | 1003 |
| 8 | 121 | 408 | 1015 |
| 9 | 100 | 407 | 1022 |
| 10 | 86 | 407 | 1026 |

Table 3, below, lists the properties of the resulting polystyrene foam. As shown in Table 3, extruded polystyrene foam produced using the novel tertiary blowing agent blends demonstrated foam densities between 2.13 and 2.27 lbs/ft³, projected R values after 180 days of at least 4.9 and compressive strengths of at least 42 psi.

TABLE 3
Physical properties of pilot line 1-inch XPS foam samples produced
with the exemplary tertiary blowing agent blends in Table 1

| | Foam | Projected | Average | | Open | Compressive | |
|---|---|---|---|---|---|---|---|
| Sample | Density | 180-days | Cell Sizes | | Cells | Strength | LOI |
| No | (lb/ft³) | R/in | (mm) | X:Z | (mm) | (psi) | (%) |
| 1 | 2.21 | 4.95 | 0.17 | 1.06 | 1.16 | 43.5 | 26.0 |
| 2 | 2.21 | 4.97 | 0.18 | 1.06 | 2.19 | 44.2 | 24.4 |
| 3 | 2.16 | 4.95 | 0.18 | 1.00 | 0.81 | 43.3 | 24.5 |
| 4 | 2.13 | 4.96 | 0.18 | 1.00 | 1.56 | 42.4 | 25.6 |
| 5 | 2.15 | 4.96 | 0.17 | 1.06 | 0.72 | 43.3 | 25.0 |
| 6 | 2.20 | 4.96 | 0.17 | 1.06 | 2.47 | 43.7 | 25.0 |
| 7 | 2.20 | 4.99 | 0.17 | 1.06 | 1.26 | 42.0 | 26.0 |
| 8 | 2.27 | 4.97 | 0.18 | 1.06 | 2.02 | 45.2 | 25.7 |
| 9 | 2.33 | 4.99 | 0.18 | 1.06 | 0.75 | 46.3 | 25.3 |

### Example 2

Extruded polystyrene foam samples prepared using a twin screw pilot line extruder. Polystyrene was melted in the extruder and mixed with an injected blowing agent composition to form a homogeneous foamable composition. The foamable composition (excluding the blowing agent) included 98.4 wt. % polystyrene, 1.0 wt. % flame retardant masterbatch, and 0.60 wt. % graphite masterbatch. Tri-blend blowing agent blends were included with varying concentrations of fluorinated alkene and dual co-blowing agent mixtures. The foamable composition was then cooled to the right foaming conditions, including a die temperature between 110° C. and 130° C. and foaming die pressure between 800 and 1100 psi. The foamable compositions were then extruded to produce 1-inch XPS foam samples. Each of the blowing agent compositions are provided below in Table 4.

TABLE 4
Exemplary tertiary blowing agent blends

| | Wt. % based on total weight | | | | | | | |
|---|---|---|---|---|---|---|---|---|
| | of the foamable mixture | | | | Amount of blowing agent in moles | | | |
| | HFC- | HFC- | HFO- | Total | HFC- | HFC- | HFO- | Total |
| Sample | 134a | 152a | 1336mzz | BA | 134a | 152a | 1336mzz | Gas |
| No | (%) | (%) | (%) | (%) | (moles) | (moles) | (moles) | (moles) |
| 1 | 1.83 | 4.80 | 1.17 | 7.80 | 0.0179 | 0.0726 | 0.0071 | 0.0977 |
| 2 | 0.90 | 4.80 | 2.11 | 7.81 | 0.0088 | 0.0726 | 0.0129 | 0.0943 |
| 3 | 0.20 | 4.80 | 2.81 | 7.81 | 0.0020 | 0.0726 | 0.0171 | 0.0917 |
| 4 | 0.16 | 4.80 | 2.84 | 7.80 | 0.0016 | 0.0726 | 0.0173 | 0.0915 |
| 5 | 0.12 | 4.80 | 2.88 | 7.80 | 0.0012 | 0.0726 | 0.0176 | 0.0913 |
| 6 | 0.08 | 4.80 | 2.92 | 7.80 | 0.0008 | 0.0726 | 0.0178 | 0.0912 |
| 7 | 0.04 | 4.80 | 2.96 | 7.80 | 0.0004 | 0.0726 | 0.0180 | 0.0910 |

Table 5, below, lists the properties of the resulting polystyrene foam. As shown in Table 5, extruded polystyrene foam produced using the novel tertiary blowing agent blends detailed in Table 4 demonstrated foam densities between 1.6 and 1.78 lbs/ft³ and projected R values after 180 days of at least 4.84.

Each of the extruded polystyrene foam boards were then tested for flammability in accordance with NFPA-286 corner room burn test. The NFPA-286 test measures the combustibility of foam, whereby all of the foam components burn, releasing additional energy in the form of heat measured in British thermal units (BTU). The amount of heat liberated during the combustion process is dependent on each component's size and molecular composition. In the case of HFO-1336mzz(Z), it is much larger molecule than HFC-134a/HFC-134 and contains a double bond, which is significantly more reactive than a single bond. Therefore, conventional foams manufactured using HFO-1336mzz(Z) are unable to pass the NFPA-286 test.

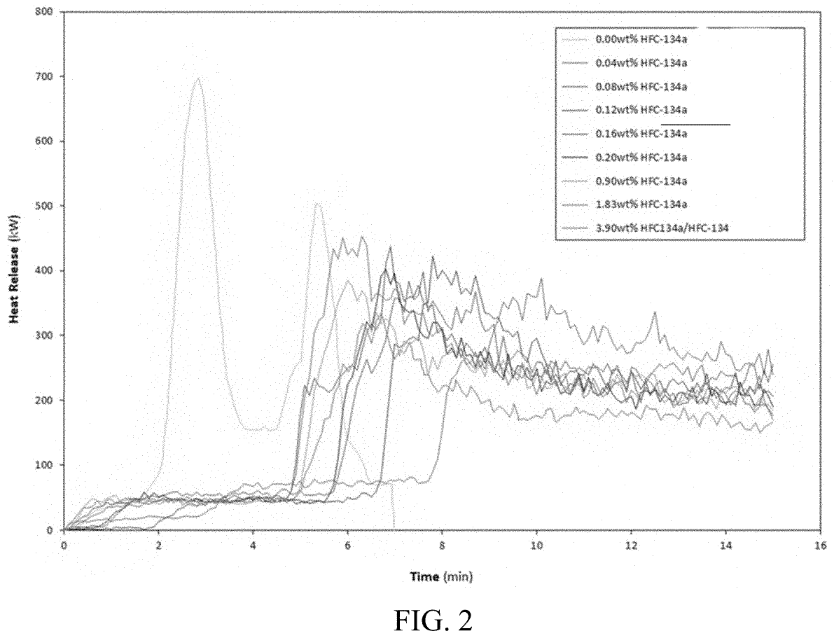

For each of the foam samples, sixty 8-ft boards were packaged and shipped to Intertek for NFPA-286 testing. Each room assembly, walls only, containing 1-inch double stacked XPS foam boards, were built and tested in accordance with NFPA-286-19, Standard Methods of Fire Tests for evaluating Contribution of Wall and Ceiling Interior Finish to Room Fire Growth and International Building Code (2015), Chapter 8, Section 803.1.2.1. FIG. 2 illustrates the heat release results of the NFPA corner room burn test for double stacked 1-inch XPS foam boards with high levels of HFC-134a (3.9 wt. %), low levels of HFC-134a, and that are free of HFC-134a (included only HFO-1336mzz-Z and HFC-152a). The 0 wt. % HFC-134a sample was 2 inches thick and single stacked.

As illustrated in Table 5, below, each of the foam board samples containing the tertiary blowing agents passed the NFPA-286 test. In contrast, the sample produced with a blowing agent free of HFC-134a did not pass the NFPA-286 test, as illustrated in FIG. 2.

TABLE 5
Physical properties of pilot line 1-inch XPS foam samples
produced with the exemplary tertiary blowing agent blends
in Table 4 tested in NFPA-286 test “corner room burn”

| | Foam | Projected | Average | | Open | | |
|---|---|---|---|---|---|---|---|
| Sample | Density | 180-days | Cell Sizes | | Cells | LOI | NPA- |
| No | (lb/ft³) | R/in | (mm) | X:Z | (mm) | (%) | 286 |
| 1 | 1.71 | 4.88 | 0.19 | 1.06 | 2.21 | 24.5 | Passed |
| 2 | 1.67 | 4.85 | 0.18 | 1.06 | 2.03 | 23.7 | Passed |
| 3 | 1.66 | 4.85 | 0.18 | 1.00 | 1.47 | 26.5 | Passed |
| 4 | 1.77 | 4.87 | 0.17 | 0.94 | 3.40 | 24.5 | Passed |
| 5 | 1.73 | 4.86 | 0.18 | 1.00 | 8.27 | 24.8 | Passed |
| 6 | 1.73 | 4.84 | 0.18 | 1.00 | 3.91 | 25.2 | Passed |
| 7 | 1.78 | 4.89 | 0.18 | 0.94 | 6.18 | 26.0 | Passed |

### Example 3

Extruded polystyrene foam samples prepared using a twin screw pilot line extruder. Polystyrene was melted in the extruder and mixed with an injected blowing agent composition to form a homogeneous foamable composition. The foamable composition (excluding the blowing agent) included 98.4 wt. % polystyrene, 1.0 wt. % flame retardant masterbatch, and 0.60 wt. % graphite masterbatch. Tri-blend blowing agent blends were included with varying concentrations of fluorinated alkene and dual co-blowing agent mixtures. The foamable composition was then cooled to the right foaming conditions, including a die temperature between 110° C. and 130° C. and foaming die pressure between 800 and 1100 psi.

The foamable compositions were then extruded to produce 1-inch XPS foam samples. Each of the blowing agent compositions are provided below in Table 6.

TABLE 6
Exemplary tertiary blowing agent blends

| | HFC- | HFC- | HFO- | Total | HFC- | HFC- | HFO- | Total |
|---|---|---|---|---|---|---|---|---|
| Sample | 134a | 152a | 1234ze | BA | 134a | 152a | 1234ze | Gas |
| No | (wt. %) | (wt. %) | (wt. %) | (wt. %) | (moles) | (moles) | (moles) | (moles) |
| 1 | 0.31 | 3.51 | 3.98 | 7.80 | 0.0030 | 0.0531 | 0.0349 | 0.0910 |
| 2 | 0.08 | 3.51 | 4.21 | 7.80 | 0.0008 | 0.0531 | 0.0369 | 0.0908 |
| 3 | 0.02 | 3.51 | 4.27 | 7.80 | 0.0002 | 0.0531 | 0.0374 | 0.0907 |
| 4 | 0.00 | 3.51 | 4.29 | 7.80 | 0.0000 | 0.0531 | 0.0376 | 0.0907 |

As illustrated in Table 7, each of the novel tertiary blowing agent blends maintained a total GWP below 450. Additionally, the heat of combustion decreases with increasing HFC-134a, which indicates that the foam should have better flammability properties, and the blowing agent efficiency improves, as shown below.

TABLE 7
Calculated GWP, blowing agent efficiency, and heat of combustion
values for the blowing agent blends in Table 6.

| | HFC- | HFC- | HFO- | GWP | BA | |
|---|---|---|---|---|---|---|
| Sample | 134a | 152a | 1234ze | (5th | Efficiency | Calc. - ΔHc |
| No | (%) | (%) | (%) | Assessment) | @121° C. | (kJ · mol⁻¹) |
| 1 | 4.00 | 45.0 | 51.0 | 119 | 398 | 998 |
| 2 | 1.03 | 45.0 | 54.0 | 77 | 397 | 1011 |
| 3 | 0.26 | 45.0 | 54.7 | 66 | 397 | 1014 |
| 4 | 0.00 | 45.0 | 55.0 | 63 | 397 | 1015 |

Each of the extruded polystyrene foam boards produce according to Table 7 were then tested for flammability in accordance with NFPA-286 corner room burn test.

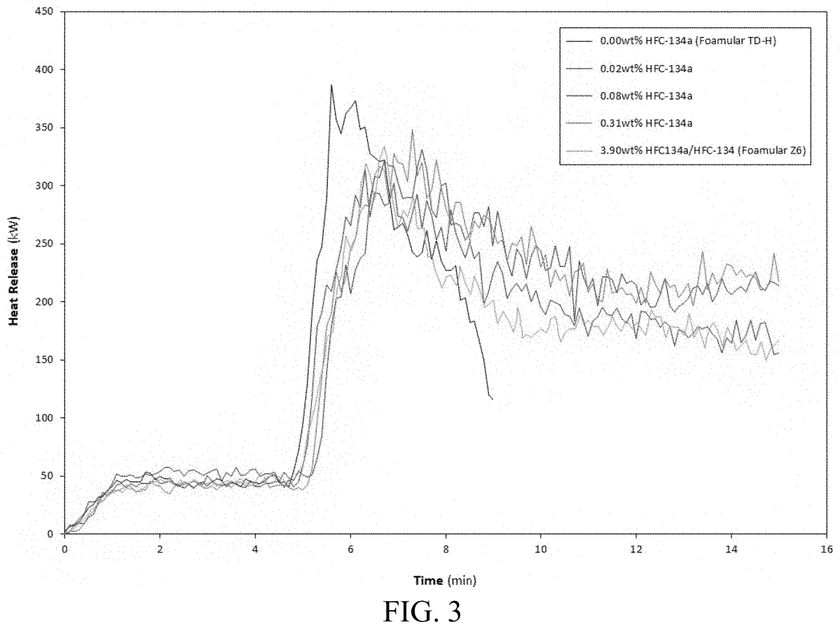

For each of the three foam samples, sixty 8-ft boards were packaged and shipped to Intertek for NFPA-286 testing. Each room assembly, walls only, containing 1-inch double stacked XPS foam boards, were built and tested in accordance with NFPA-286-19, Standard Methods of Fire Tests for evaluating Contribution of Wall and Ceiling Interior Finish to Room Fire Growth and International Building Code (2015), Chapter 8, Section 803.1.2.1. FIG. 3 illustrates the heat release results of the NFPA corner room burn test for double stacked 1-inch XPS foam boards with high levels of HFC-134a (3.9 wt. %), that is free of HFC-134a (includes only HFO-1234ze and HFC-152a) and low levels of HFC-134a. The 0 wt. % HFC-134a sample was 2 inches thick and single stacked.

As illustrated in Table 8, below, each of the foam board samples containing the tertiary blowing agents passed the NFPA-286 test. In contrast, the sample produced with a blowing agent free of HFC-134a did not pass the NFPA-286 test, as illustrated in FIG. 3.

TABLE 8
Physical properties of pilot line 1-inch XPS foam samples
tested in NFPA-286 test “corner room burn”

| | Foam | Projected | Average | | Open | | |
|---|---|---|---|---|---|---|---|
| Sample | Density | 180-days | Cell Sizes | | Cells | LOI | NPA- |
| No | (lb/ft³) | R/in | (mm) | X:Z | (mm) | (%) | 286 |
| 1 | 1.76 | 4.89 | 0.17 | 1.00 | 3.31 | 26.5 | Passed |
| 2 | 1.75 | 4.90 | 0.17 | 1.00 | 6.81 | 25.5 | Passed |
| 3 | 1.74 | 4.90 | 0.17 | 1.00 | 3.08 | 25.5 | Passed |
| 4 | 1.79 | 4.94 | 0.17 | 1.00 | 6.33 | 26.2 | Passed |

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A foamable polymer composition comprising:
a) a thermoplastic matrix polymer composition, and
b) a tri-blend blowing agent composition comprising:
5 wt. % to 55 wt. % of a fluorinated alkene having a GWP less than 5;
30 wt. % to 80 wt. % of a first co-blowing agent comprising a hydrofluorocarbon (HFC) blowing agent having a GWP less than 200; and
0.25 to 25 wt. % of a second co-blowing agent comprising an HFC blowing agent having a GWP above 500, wherein the tri-blend blowing agent composition has a total GWP of less than 550, and wherein said foamable polymer composition produces a polymer foam having a density less than 40 kg/m³ and passes NFPA-286 corner room burn test.

2. The foamable polymer composition of claim 1, wherein the fluorinated alkene comprises one of trans-1,1,1,4,4,4-hexafluoro-2-butene (HFO-1336mzz-Z) or 1,3,3,3-tetrafluoropropene (HFO-1234ze).

3. The foamable polymer composition of claim 1, wherein the fluorinated alkene is present in the foamable polymer composition in an amount between 0.001 moles and 0.038 moles per 100 grams of the of the matrix polymer.

4. The foamable polymer composition of claim 1, wherein the first co-blowing agent comprises 1,1-difluoroethane (HFC-152a), fluoroethane (HFC-161), fluoromethane (HFC-41), or combinations thereof.

5. The foamable polymer composition of claim 1, wherein the second co-blowing agent comprises 1,1,1,2-tetrafluoroethane (HFC-134a), 1,1,2,2-tetrafluoroethane (HFC-134), 1,1,1-trifluoroethane (HFC-143a), difluoromethane (HFC-32), pentafluoro-ethane (HFC-125), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-236cb), 1,1,2,3,3-pentafluoropropane (HFC-245 ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

6. The foamable polymer composition of claim 1, wherein the second co-blowing agent is present in an amount between 0.0005 moles and 0.03 moles per 100 grams of the matrix polymer.

7. The foamable polymer composition of claim 1, wherein the second co-blowing agent comprises less than 0.020 moles/100 grams of matrix polymer.

8. The foamable polymer composition of claim 1, wherein the matrix polymer is selected from the group consisting of alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polymethylmethacrylate, polyacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyphenylene sulfide, acetal resins, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

9. The foamable polymer composition of claim 1, wherein the tri-blend blowing agent composition has a GWP of no greater than 300.

10. The foamable polymer composition of claim 1, wherein the tri-blend blowing agent composition is free of at least one of water and carbon dioxide.

11. A foamed polymeric insulation product comprising:
a polymeric foam composition formed from a foamable polymer composition comprising:
a) a thermoplastic matrix polymer composition, and
b) a tri-blend blowing agent composition comprising:
5 wt. % to 55 wt. % of trans-1,1,1,4,4,4-hexafluoro-2-butene (Z-HFO-1336mzz);
30 wt. % to 75 wt. % of a first co-blowing agent comprising a hydrofluorocarbon (HFC) blowing agent having a GWP less than 200; and
0.25 to 25 wt. % of a second co-blowing agent comprising an HFC blowing agent having a GWP above 500, said tertiary blowing agent composition having a total GWP of less than 550, wherein said foamable polymer composition produces a polymer foam having compressive strength between 41 psi and 48 psi and passes NFPA-286 corner room burn test.

12. The foamed polymeric insulation product of claim 11, wherein the insulation product has a thermal resistance value (R-value) after 180 days of at least 4.75 per inch.

13. The foamed polymeric insulation product of claim 11, wherein the foamable polymer composition is free of graphite.

14. The foamed polymeric insulation product of claim 11, wherein the insulation product has a calculated heat of combustion that is less than 1100 kJ-mol⁻¹.

15. The foamed polymeric insulation product of claim 11, wherein the first co-blowing agent comprises 1,1-difluoroethane (HFC-152a), fluoroethane (HFC-161), fluoromethane (HFC-41), or combinations thereof.

16. The foamed polymeric insulation product of claim 11, wherein the second co-blowing agent comprises 1,1,1,2-tetrafluoroethane (HFC-134a), 1,1,2,2-tetrafluoroethane (HFC-134), 1,1,1-trifluoroethane (HFC-143a), difluoromethane (HFC-32), pentafluoro-ethane (HFC-125), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-236cb), 1,1,2,3,3-pentafluoropropane (HFC-245 ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

17. The foamed polymeric insulation product of claim 11, wherein trans-1,1,1,4,4,4-hexafluoro-2-butene is present in the foamable polymer composition in an amount between 0.001 moles and 0.025 moles per 100 grams of the of the matrix polymer.

18. The foamed polymeric insulation product of claim 11, wherein the second co-blowing agent comprises less than 0.020 moles/100 grams of matrix polymer.

19. A foamable polymer composition comprising:
a) 85 wt. % to 95 wt. % of a thermoplastic matrix polymer composition, and
b) 5 wt. % to 10 wt. % of a tri-blend blowing agent composition, the blowing agent composition comprising:
0.5 wt. % to 3 wt. % of trans-1,1,1,4,4,4-hexafluoro-2-butene (Z-HFO-1336mzz), based on the total weight of the foamable polymer composition;
3 wt. % to 5 wt. % of a first co-blowing agent comprising a hydrofluorocarbon (HFC) blowing agent having a GWP less than 200, based on the total weight of the foamable polymer composition; and
0.01 to 2 wt. % of a second co-blowing agent comprising an HFC blowing agent having a GWP above 500, based on the total weight of the foamable polymer composition, said tertiary blowing agent composition having a total GWP of less than 550, wherein said foamable polymer composition produces a polymer foam having a density less than 40 kg/m³ and passes NFPA-286 corner room burn test

20. A method of manufacturing polymer foam, comprising:
a) providing a matrix polymer melt into an extruder;
b) injecting a tri-blend blowing agent composition into the matrix polymer melt within the extruder to form a foamable polymer composition, wherein the tri-blend blowing agent comprises:
5 wt. % to 55 wt. % of a fluorinated alkene having a GWP less than 5;
30 wt. % to 75 wt. % of a first co-blowing agent comprising a hydrofluorocarbon (HFC) blowing agent having a GWP less than 200; and
0.25 to 25 wt. % of a second co-blowing agent comprising an HFC blowing agent having a GWP above 500, said tertiary blowing agent composition having a total GWP of less than 550,
c) extruding the foamable polymer composition to form a polymer foam, wherein said polymer foam has a compressive strength between 41 psi and 48 psi and passes NFPA-286 corner room burn test.
